(19) United States
(12) Patent Application Publication
(10) Pub. No.: US 2022/0184564 A1
(43) Pub. Date: Jun. 16, 2022

(54) ASYMMETRICALLY POROUS ION EXCHANGE MEMBRANES AND THEIR METHOD OF MANUFACTURE

(71) Applicant: MONASH UNIVERSITY, Clayton (AU)

(72) Inventors: Huanting WANG, Glen Waverley (AU); Xiaocheng LIN, Clayton (AU)

(21) Appl. No.: 17/653,096

(22) Filed: Mar. 1, 2022

Related U.S. Application Data
(63) Continuation-in-part of application No. 15/773,851, filed on May 4, 2018, now abandoned.

(30) Foreign Application Priority Data
Nov. 5, 2015 (AU) 2015904542

(51) Int. Cl. B01D 69/12; B01D 67/00; B01D 69/02

(52) U.S. Cl. CPC B01D 69/125; B01D 67/0088; B01D 67/0006; B01D 2325/026; B01D 2325/42; B01D 2325/022; B01D 69/02

(57) ABSTRACT

The disclosure relates to a membrane and method for its manufacture, the method including the steps of providing of an ultrafiltration membrane, and modification of the resultant ultrafiltration membrane to provide an asymmetric porous ion exchange membrane. The modification of the ultrafiltration membrane is typically carried out by exposing said ultrafiltration membrane to a first functional reagent to provide a cross-linked ultrafiltration membrane, and then exposing said cross-lined ultrafiltration membrane to a second functional reagent to introduce positive charged groups to produce an anion exchange membrane.

### CROSS REFERENCE TO RELATED APPLICATIONS

The present application is a continuation-in-part of U.S. Non-Provisional patent application Ser. No. 15/773,851, entitled “ASYMMETRICALLY POROUS ION EXCHANGE MEMBRANES AND THEIR METHOD OF MANUFACTURE”, and filed on May 4, 2018. U.S. Non-Provisional patent application Ser. No. 15/773,851 is a U.S. National Phase of International Application No. PCT/AU2016/000370, entitled “ASYMMETRICALLY POROUS ION EXCHANGE MEMBRANES AND THEIR METHOD OF MANUFACTURE”, and filed on Nov. 2, 2016. International Application No. PCT/AU2016/000370 claims priority to Australian Patent Application No. 2015904542 filed on Nov. 05, 2015. The entire contents of each of the above-listed applications are hereby incorporated by reference for all purposes.

### TECHNICAL FIELD

The present disclosure relates to the field of membrane technology. In one form, the disclosure relates to a new asymmetrically porous ion exchange membrane and a method of manufacture thereof.

### BACKGROUND

It is to be appreciated that any discussion of documents, devices, acts or knowledge in this specification is included to explain the context of the present disclosure. Further, the discussion throughout this specification comes about due to the realisation of the inventor and/or the identification of certain related art problems by the inventor. Moreover, any discussion of material such as documents, devices, acts or knowledge in this specification is included to explain the context of the disclosure in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure.

Large amounts of acidic or basic waste solutions produced from industrial production cause serious environmental problems and resource waste. The common acid/base waste treatments of the prior art suffer from high energy consumption and increase pollution by generating salt by-products. Acid/base recovery via diffusion dialysis employing ion exchange membranes has been used for many years due to its operational simplicity, compatibility with either small or large plating plants, and economic advantages in terms of capital investment and operating costs.

However, the processing capacity and efficiency of diffusion dialysis systems are still quite low (e.g., 11.3 L·m⁻²·d⁻¹ for the commercial DF-120 membrane with acid recovery of 85-90%), thus requiring large membrane areas for industrial applications. This drawback is due to the low ion permeation of the ion exchange membranes used, which are generally prepared by direct evaporation of quaternized polymer solution.

Numerous efforts have been made in the past to improve the diffusion dialysis performance of the dense ion exchange membranes by modifying their structure. However, the membrane microstructure of the prior art remains of dense structure and improvement is thus limited. There is therefore an ongoing need to create improved structures with concomitantly improved performance.

### SUMMARY

An object of the present disclosure is to provide membranes having improved diffusion dialysis performance.

Another object of the present disclosure is to create improved membrane structures or at least improve existing membrane structures.

A further object of the present disclosure is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a method for manufacture of a membrane comprising the step of direct conversion of an ultrafiltration membrane having an asymmetric microstructure after modification such as by the steps of cross-linking and charging treatment.

In a second aspect of embodiments described herein there is provided a method for manufacture of a membrane comprising the steps of:

(1) provision of an ultrafiltration membrane, and

(2) modification of the resultant ultrafiltration membrane to provide an asymmetrically porous ion exchange membrane.

In contrast with the dense ion exchange membranes of the prior art which are typically dense and of symmetric structure, the asymmetrically porous membranes produced by the method of the present disclosure have a different micro-structure and a different ion transfer rate through the membrane matrix. Typically the membranes of the present disclosure have an asymmetrical microstructure with a dense top surface without observable pores (that is, pores typically having a diameter of less than 0.8 nm), a thin nanoporous active layer, macroporous supporting layer with asymmetrically porous channels within the cross section and a macroporous bottom surface. Without wishing to be bound by theory it is believed that blocking the nanopores of the skin layer is responsible for the high acid/base permeability.

The ultrafiltration membrane of step (1) may be pre-manufactured according to any convenient means and may comprise at least one halogen methylated polymer. Alternatively, the ultrafiltration membrane of step (1) may be prepared from a starting polymer selected from halogen methylated polymers such as chloromethylated polysulfone (PS—Cl), chloromethylated polyethersulfone (PES—Cl), chloromethylated poly(ether ketone) (PEK—Cl), chloromethylated poly (ether ether ketone) (PEEK—Cl), chloromethylated poly (phthalazinone ether sulfone ketone) (PPESK—Cl) and bromomethylated poly (phenylene oxide) (BPPO).

Typically, step (2) comprises modification of the ultrafiltration membrane using a one-step or two-step method to produce a porous ion exchange membrane.

In a third aspect of embodiments described herein there is provided a method for manufacture of a membrane comprising the steps of:

(1)(i) forming a solution comprising 10 to 40 wt % of one or more halogen methylated polymers,

(1)(ii) casting the solution to a thickness of 10 to 500 micron, and

(1)(iii) subjecting the cast solution to a coagulation bath to form an ultrafiltration membrane, and

(2) modification of the resultant ultrafiltration membrane by exposing it to at least one functional reagent to provide a porous ion exchange membrane.

Step (2) may comprise one or two sub-steps. In a fourth aspect of embodiments described herein there is provided a method for manufacture of a membrane comprising the steps of:

(1) preparation of an ultrafiltration membrane using a polymer, and

(2) modification of the resultant ultrafiltration membrane to provide a porous ion exchange membrane by;

exposing said ultrafiltration membrane to a bis-functional reagent, or

exposing said ultrafiltration membrane to (i) a first functional reagent to provide a cross-linked ultrafiltration membrane, and then (ii) a second functional reagent to introduce positive charged groups into the membranes to produce an anion exchange membrane, or

exposing said ultrafiltration membrane to (i) a first functional reagent to cross-link the ultrafiltration membrane and then (ii) a second functional reagent to introduce negatively charged groups into the membranes to produce a cation exchange membrane.

For the one step method for anion exchange membrane preparation, the bis-functional reagent is selected from the group comprising imidazoles and amines containing at least two amine groups and at least one of them should be a tertiary amine group, such as N,N,N′,N′--tetramethylethylenediamine, N,N,N′,N′--tetramethyl-1,3 -propanediamine, N,N,N′,N′--tetramethyl-1,4-butanediamine, N,N,N′,N′--tetramethyl-1,6-hexanediamine, N,N-dimethylethylenediamine, 3 -(dimethylamino)-1-propyl amine, 3,3′-iminobis(N,N-dimethylpropylamine), and 1,4-diazabicyclo [2.2.2] octane.

Typically the first functional reagent is selected from amines containing at least two amine groups, such as ethylenediamine, hexamethylenediamine, diethylenetriamine, diethylenetriamine, pentaethylenehexamine, poly(ethyleneimine) and poly(ethylene glycol) bis(amine), or mixtures thereof.

Typically the second functional reagents for anion exchange membrane preparation is selected from the molecules that can be transferred to positively charged compound after reaction with halomethyl such as N-substituted imidazole, tris(3,5-dimethylphenyl)phosphine, tris(2,4,6-trimethoxyphenyl)phosphine, tris(2,4,6-trimethylphenyl)phosphine, tris(3,5-dimethylphenyl)phosphine, or amines molecules with a tertiary amine group such as trimethylamine, tripropylamine and trihexylamine or mixtures thereof.

Typically the second functional reagents for cation exchange membrane preparation is selected from the molecules that can and introduce negatively charged groups after reaction with membrane substrate such as concentrated sulfuric acid, chlorosulfonic acid, potassium 4-(1H-indol-3-yl)butanoate, 3-Indoleacetic acid, Indole-3-butyric acid.

For the one step or two step method the first and second functional reagents can be used neat or diluted with solvent(s) depending on the nature of the reagents.

In another aspect of embodiments described herein there is provided an ultrafiltration membrane manufactured according to the method of the present disclosure comprises,

a dense top surface without observable pores,

a thin nanoporous active layer,

a macroporous supporting layer with asymmetrically porous channels within the cross section, and

a macroporous bottom surface.

In yet a further aspect of embodiments described herein there is provided a membrane manufactured according to the method of the present disclosure , the membrane has an asymmetrical microstructure with (i) a dense top surface, (ii) a thin nanoporous active layer, (iii) a macroporous supporting layer with asymmetrically porous channels, and (iv) a macroporous bottom surface.

Other aspects and forms are disclosed in the specification, forming a part of the description of the disclosure.

In essence, embodiments of the present disclosure stem from the realization that particular features incorporated into a membrane structure can significantly improve diffusion dialysis performance. In particular the realisation is based at least in part in the realisation that blocking or eliminating nanopores in the skin layer of an ultrafiltration membrane can increase the acid/base permeability and the separation factor.

Aspects of the present disclosure comprise the following:

the method for manufacture of the membranes is simple and effective,

the membranes have potential to improve process capacity and efficiency of diffusion dialysis, such as for rapid acid/base recovery,

the membranes have ultrahigh acid/base permeability and separation factor,

the membranes have low effective thickness and high porosity.

Further scope of applicability of embodiments of the present disclosure will become apparent from the detailed description given hereinafter. However, it should be understood that the detailed description and specific examples, while indicating certain embodiments of the disclosure, are given by way of illustration only, since various changes and modifications within the spirit and scope of the disclosure herein will become apparent to those skilled in the art from this detailed description.

### BRIEF DESCRIPTION OF THE FIGURES

Further disclosure, objects, and aspects of other embodiments of the present application may be better understood by those skilled in the relevant art by reference to the following description of embodiments taken in conjunction with the accompanying drawings, which are given by way of illustration only, and thus are not limitative of the disclosure herein, and in which:

FIGS. 1A-1B are schematic representations of the cross-section morphologies and ion transfer mechanisms of (FIG. 1A) dense anion exchange membranes and (FIG. 1B) asymmetrically porous anion exchange membranes (where H⁺ indicates protons, A⁻ indicates anions, and M⁺ indicates metal ions);

FIGS. 2A-2B is a schematic representation of the cross-section morphologies and ion transfer mechanisms of (FIG. 2A) dense cation exchange membranes and (FIG. 2B) asymmetrically porous cation exchange membranes (where OH⁻ indicates hydroxide ions, C⁺ indicates cations and A⁺ indicates anions; nanochannel (2); wall (4); water (6));

FIG. 3 is a schematic representation of the steps involved in the method of manufacture of a porous anion/cation exchange membrane according to the present disclosure. The schematic shows:

1 - addition of organic solvent to apolymer to form a polymer
solution
3 - applying a micrometer film applicator
5 - applying to a substrate
7 - forming a casting solution
9 - subjecting the casting solution of af a coagulation bath
11 - formation of an ultrafiltration membrane
13 - formation of halogen methylated polymers
15 - modification of the ultrafiltration membrane by addition
of a bis-functional reagent
17 - formation of a porous anion exchange membrane
19 - addition of a first functional reagent to cause cross-
linking
21 - addition of an alternative second functional reagent to
introduce positively charged groups
23 - formation of a cross-linked ultrafiltration membrane
25 - formation of a porous anion exchange membrane
27 - addition of another second functional reagent to introduce
negatively charged groups
29 - formation of a porous cation exchange membrane

FIG. 4 is a representation of a high-resolution XPS spectra of N1s region of BPPO (30) and TPPO (32) membranes;

FIGS. 5A-5D comprises SEM images of a porous TPPO ultrafiltration membrane depicting (FIG. 5A) the top surface, (FIG. 5B) the bottom surface, (FIG. 5C) the cross section of the overall membrane (FIG. 5D) the cross section of the skin layer with a thickness of sub-1 μm;

FIG. 6 is a representation of high-resolution XPS spectra of N1s region of BPPO (34), BBPPO (36) and BTPPO (38) membranes;

FIGS. 7A-7D comprises SEM images of BTPPO ultrafiltration membrane depicting (FIG. 7A) the top surface, (FIG. 7B) the bottom surface, (FIG. 7C) the cross section of the overall membrane (FIG. 7D) the cross section of the skin layer with a thickness of sub-1 μm;

FIG. 8 illustrates the acid dialysis coefficient and separation factor of TPPO (▪), BTPPO (●), commercially available DF120 membrane (▴) and some other membranes of the prior art (▾).

### DETAILED DESCRIPTION

In contradistinction to dense membranes, ultrafiltration membranes have a thin nanoporous skin layer with a thickness of sub-micrometer and a thick and macroporous supporting layer. Typical ultrathin membranes of the prior art are described by Guillen et al., in Preparation and Characterization of Membranes Formed by Nonsolvent Induced Phase Separation: A Review, Industrial & Engineering Chemistry Research, 2011, 50(7), p. 3798-3817. High acid/base permeability can be expected after the nanopores of the skin layer have been blocked.

Typically, the transport of small molecules across a dense or nonporous polymer membrane follows a solution-diffusion mechanism involving sorption of solutes into the membrane, diffusion across the membrane and desorption of solutes out of the membrane. Among these processes, diffusion across the membrane under a ‘hopping’ mechanism or ‘vehicular’ mechanism is the most important and largely dependent on the free volume of the polymer.

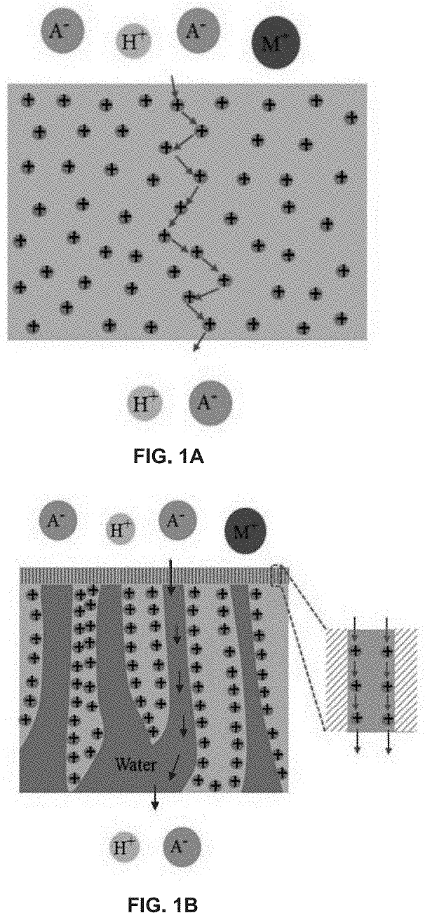

FIGS. 1A-1B show the cross-section morphologies of (FIG. 1A) a dense anion exchange membrane and (FIG. 1B) an asymmetrically porous anion exchange membrane for diffusion dialysis and the proton transfer mechanisms through them.

For dense anion exchange membranes, ion transfer rate is low because of the less free volume and the high thickness (dozens to hundreds μm). For asymmetrically porous anion exchange membranes, protons may firstly transport through the thin skin layer (typically <1 μm thick) via nano-channels. The transport rate should be higher than dense membrane with the same thickness because of the larger free volume. Afterwards, the ion transport rate in the supporting layer should be accelerated because of the abundant water absorbed in the finger-linked macro-channels.

The proton diffusivity across the whole asymmetrically porous anion exchange membrane is significantly higher than the ion diffusivity across the dense anion exchange membrane. The difference in the micro-structure between the dense and ultrafiltration membrane results in the difference in ion transfer rate in the membrane matrix. Moreover, since ultrafiltration membranes can be conveniently prepared via a phase inversion technique (such as the technique disclosed in Lin et al, J. Membrane Sci., 2015, 482(0): p. 67-75) the conversion of ultrafiltration membranes is a simple and effective method for the large-scale production of diffusion dialysis membranes with high-performance.

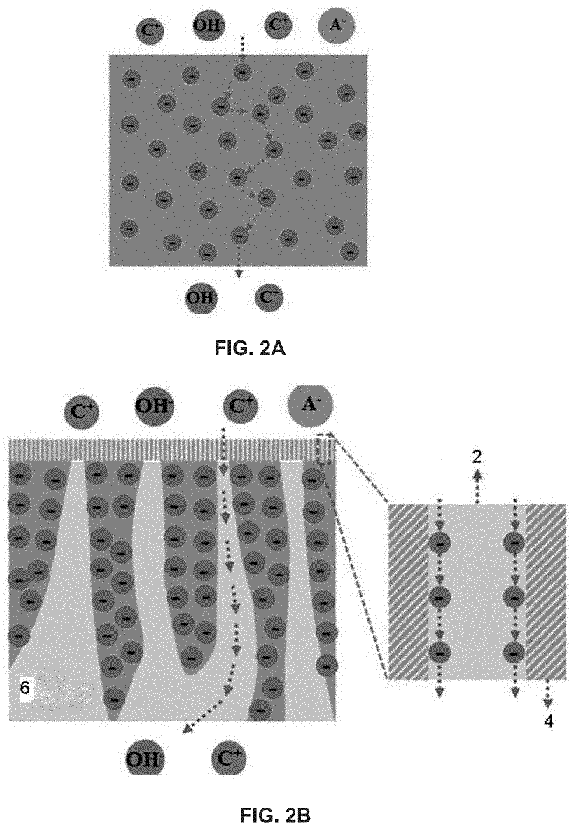

FIGS. 2A-2B show the cross-section morphologies of (FIG. 2A) a dense anion exchange membrane and (FIG. 2B) an asymmetrically porous cation exchange membrane for diffusion dialysis and the hydroxide transfer mechanisms through them.

Similar to the mechanism described for the asymmetrically porous anion exchange membrane, the hydroxide diffusivity across the whole asymmetrically porous cation exchange membrane is significantly higher than the hydroxide diffusivity across the dense cation exchange membrane. Therefore, high base permeability can be obtained.

### Manufacture of the Ultrafiltration Membrane

Step (1) of the method of manufacture according to the present disclosure comprises preparation of an ultrafiltration membrane using a polymer. As mentioned previously, the polymer can be selected from many halogen methylated polymers such as chloromethylated polysulfone (PS—Cl), chloromethylated polyethersulfone (PES—Cl), chloromethylated poly(ether ketone) (PEK—Cl), chloromethylated poly (ether ether ketone) (PEEK—Cl), chloromethylated poly (phthalazinone ether sulfone ketone) (PPESK—Cl) and bromomethylated poly (phenylene oxide) (BPPO).

The polymer is typically dissolved in a solvent. The organic solvent used for dissolving the polymer can be a single solvent or a mixture of solvents. In one embodiment, the solvent is chosen from the group comprising N-methyl-2-pyrrolidone (NMP), dimethylformamide (DMF), dimethylacetamide (DMAC), or mixtures thereof. The choice of solvent(s) will depend on the types of polymers used in the membrane fabrication, and desired microstructure of the final membranes.

The halogen methylated polymer is dissolved in organic solvent to form a casting solution. Typically, the polymer concentration is 10-40 wt %.

The solution is then cast with a typical thickness of 100-500 μm. The casting may for example be carried out using a micrometer film applicator on a clean flat substrate (such as a glass plate). The ultrafiltration membrane may be produced in a coagulation bath filled with water or other solvents, followed by washing thoroughly in deionized water. The resulting membrane is soaked in deionized water for future modification.

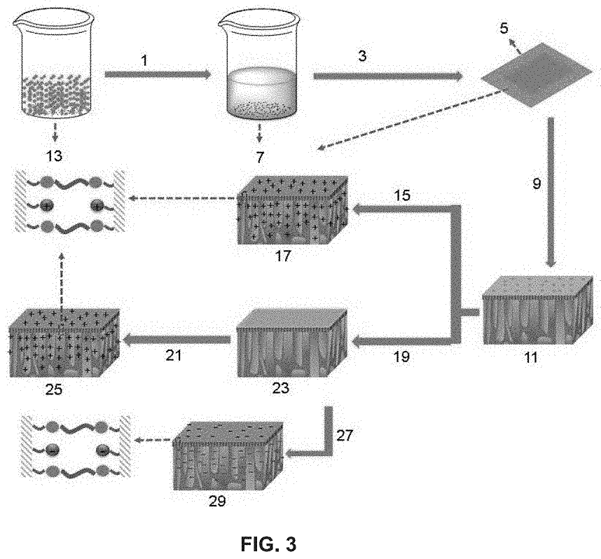

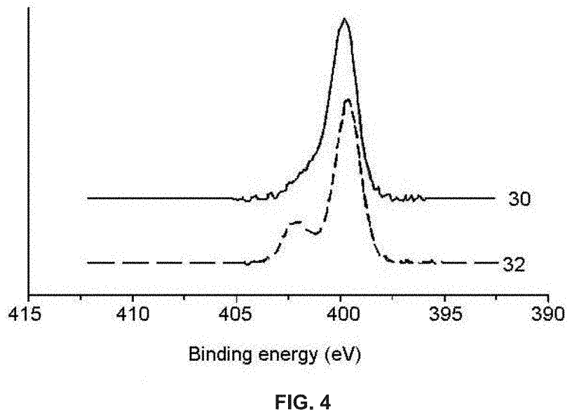

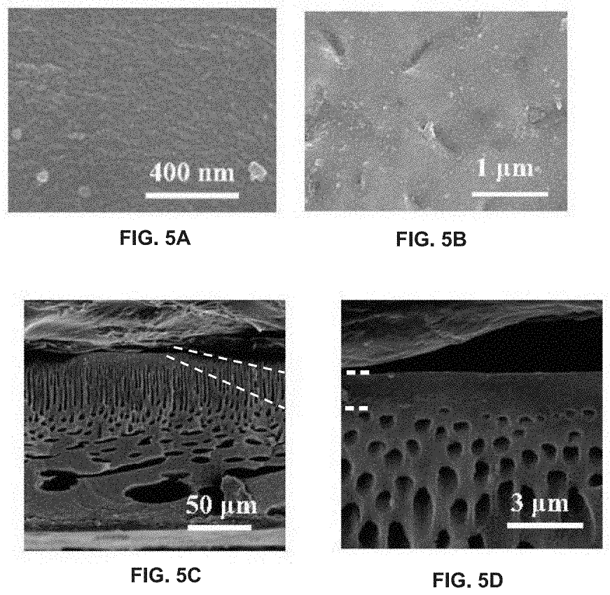

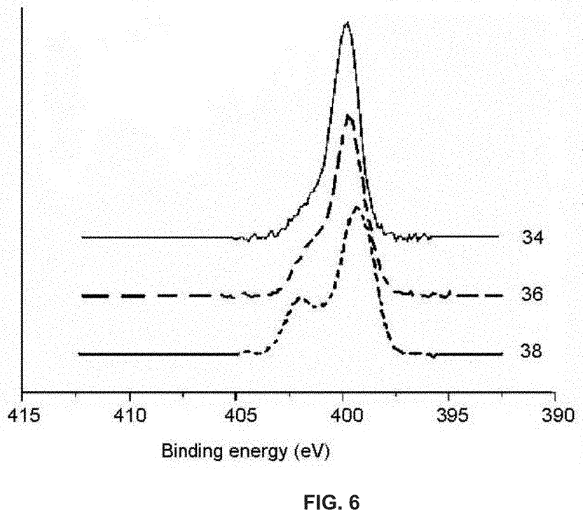

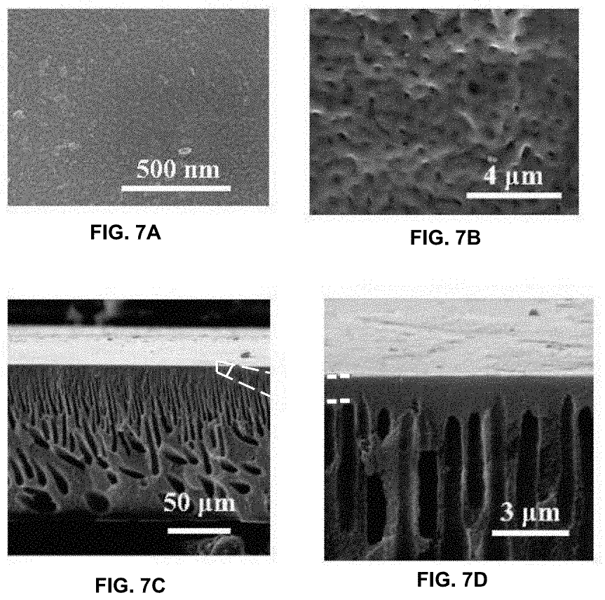

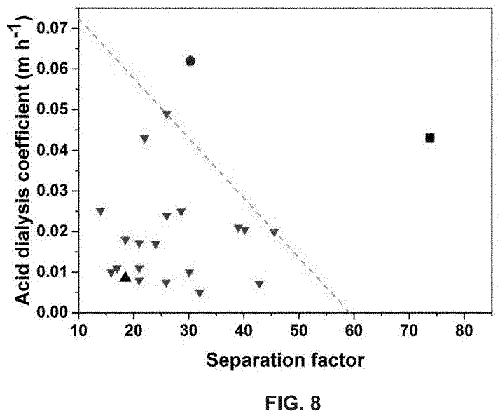

The method of manufacturing a membrane according to the present disclosure is described in the following non-limiting Examples. FIG. 3 is a schematic representation of the steps involved in the method of manufacture of an asymetrically porous anion exchange membrane according to the present disclosure.

### Example 1

### Manufacture using a Single Modification Step for Anion Exchange Membrane Preparation

Commercial bromomethylated poly (phenylene oxide) (BPPO) was used for preparation of an ultrafiltration membrane according to the present disclosure. The BPPO was dissolved in N-methyl-2-pyrrolidone to form a casting solution, which was cast onto a glass by a micrometer film applicator and then immersed into distilled water as coagulation bath to get the ultrafiltration membrane with benzyl bromide groups (—CH₂Br) groups. The ultrafiltration membrane was then modified via one-step method by soaking in N,N,N′,N′-tetramethylethylenediamine (TEMED) aqueous solution to get the final porous TPPO anion exchange membrane.

The concentration and thickness of the casting solution, the concentration of TEMED as the bis-functional reagent and the soaking temperature and time of ultrafiltration membrane in the TEMED solution can be varied to fabricate the asymmetrically porous anion exchange membranes with different diffusion dialysis properties.

For example, when the concentration and thickness of the casting solution is 30 wt % and 250 μm, respectively, the concentration of the bis-functional regent is 1 mol·L⁻¹, the soaking temperature and time are 30° C. and 4 hours, respectively, the resulting TPPO membrane has an acid dialysis coefficient of 0.043 m·h−¹ and separation factor of 73.8 when applied to recovery HCl from the mixture of HCl and FeCl₂ aqueous solution as the model acidic waste solution, which are 4.1 times and 3.0 times greater than the commercial DF-120 membrane under identical testing condition.

FIGS. 4 and 6 show high-resolution XPS spectra of N1s region of BPPO and TPPO membranes. The newly formed peak at 402.4 ev from BPPO to TPPO membrane in FIG. 6 confirms the successful introduction of quaternary ammonium (positively charged) groups into TPPO membrane.

As shown in FIGS. 5A-5D, after simultaneously crosslinking and quaternization by TEMED, the final TPPO membrane exhibits a porous structure at the supporting layer with a dense active layer (as the effective layer) with a thickness of sub-1 μm, and no observable pores at both of the top and bottom surfaces can be found. The porous micros-structure and the extremely low thickness would endow TPPO membranes with high proton permeability and hence improve the acid recovery rate when TPPO membranes were applied to recovery acid via diffusion dialysis.

### Example 2

### Manufacture using a Two Step Modification for Anion Exchange Membrane Preparation

Commercial bromomethylated poly (phenylene oxide) (BPPO) was used as the starting material for ultrafiltration membrane preparation. It was dissolved in N-methyl-2-pyrrolidone to form a casting solution with the concentration of 30 wt %, which was cast onto a glass by a micrometer film applicator whose gap was set as 250 μm and then immersed into distilled water to get the ultrafiltration membrane with benzyl bromide groups (—CH₂Br) groups. The ultrafiltration membrane was then modified via a two-step method by soaking in butanediamine (BTDA) aqueous solution to get the cross-linked BBPPO membrane and then soaking in trimethylamine (TMA) aqueous solution in turn to get the final porous BTPPO anion exchange membrane.

The concentration of BTDA and TMA aqueous solution as the first and second functional reagent, respectively, and the soaking temperature and time of ultrafiltration membrane in the BTDA and TMA solution respectively can be varied to fabricate the final porous membranes with different diffusion dialysis properties. For example, when the concentration of the BTDA solution was 1 mol·L⁻¹, the soaking temperature and time were 40° C. and 1 hour, the concentration of the TMA solution was 1 mol·L⁻¹, the soaking temperature and time were 60° C. and 6 hours. The resultant BTPPO ultrafiltration membrane had an acid dialysis coefficient of 0.062 m h⁻¹ and separation factor of 30.4 when applied to recovery HCl from the mixture of HCl and FeCl₂ aqueous solution, which are 6.3 times and 0.6 times greater than the commercial DF-120 membrane of the prior art under identical testing condition.

Like Example 1 described above, the newly formed peak at 402.4 ev for BTPPO membrane (as shown in FIG. 6) confirms the successful introduction of quaternary ammonium (positively charged) groups into BTPPO membrane.

As shown in FIGS. 7A-7D, the BTPPO membrane after treatment by BTDA and TMA also shows a porous structure at the supporting layer with a dense active layer (as the effective layer), having a thickness less than 1 μm. Moreover, no obvious pores at the top and bottom surfaces can be observed.

The acid dialysis coefficient and separation factor of TPPO and BTPPO are plotted in FIG. 8 in comparison with prior art membranes such as the commercial DF-120 membrane and some recently reported anion exchange membranes used in diffusion dialysis. In FIG. 8, the acid dialysis coefficients and separation factor of all the membranes were determined by the same testing method using a solution comprising a mixture of HCl and FeCl₂. There is a trade-off between the acid dialysis coefficient and separation factor.

As clearly shown in FIG. 8, TPPO and BTPPO membranes show extraordinarily good diffusion dialysis performance including high acid dialysis coefficient and separation factor as compared with all other membranes.

### Example 3

### Manufacture using a Two Step Modification for Cation Exchange Membrane Preparation

Commercial bromomethylated poly (phenylene oxide) (BPPO) was used as the starting material for ultrafiltration membrane preparation. It was dissolved in N-methyl-2-pyrrolidone to form a casting solution with the concentration of 30 wt %, which was cast onto a glass by a micrometer film applicator whose gap was set as 250 μm and then immersed into distilled water to get the ultrafiltration membrane with benzyl bromide groups (−CH2Br) groups. The ultrafiltration membrane was then modified via two-steps method by soaking in butanediamine (BTDA) aqueous solution to get the cross-linked BBPPO membrane and then soaking in chlorosulfonic acid aqueous solution in turn to get the final porous cation exchange membrane.

The concentration of BTDA and chlorosulfonic acid aqueous solution as the first and second functional reagent, respectively, and the soaking temperature and time of ultrafiltration membrane in the BTDA and chlorosulfonic acid solution respectively can be varied to fabricate the final porous membranes with different diffusion dialysis properties. The resultant asymmetrically porous cation membranes show good diffusion dialysis for base recovery and mechanical properties.

### Example 4

### Synthesis of Chloromethylated Polysulfone (PS—Cl) Polymer

Materials: Polysulfone (PSF, Mw˜35,000), anhydrous ferrous chloride (FeCl₂, 98%), chloroform (≥99%), paraformaldehyde (95%), trimethylchlorosilane (≥97%), stannic chloride (SnCl₄, 99%), 1-methyl-2-pyrrolidone (NMP, 99.5%), N,N,N′,N′-tetramethyl-1,3-propanediamine (TMPDA, >99%) were purchased from Sigma-Aldrich (Australia). Hydrochloric acid was purchased from Ajax Finechem Pty Ltd (Australia). Deionized water was used throughout the experiments.

As shown in Scheme 1, chloromethylatedpolysulfone (PS—Cl) was fabricated according to the previously reported method Gu et al. (S. Gu, R. Cai, T. Luo, Z. Chen, M. Sun, Y. Liu, G. He, Y. Yan, “A Soluble and Highly Conductive Ionomer for High-Performance Hydroxide Exchange Membrane Fuel Cells,” Angew. Chem. Int. Ed., 48, 2009, pp 6499-6502.):

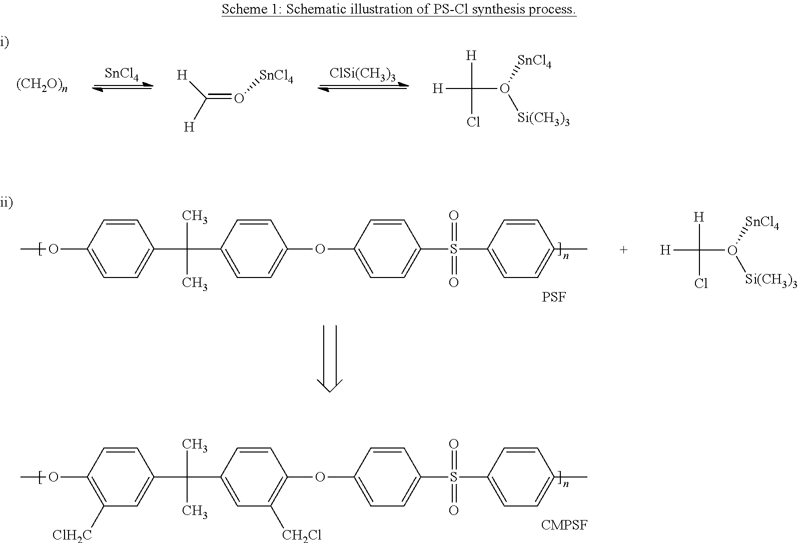

10 g of PSF was added into 500 mL of chloroform in a flask equipped with a reflux condenser to form a homogenous solution under stirring. 6.78 g of paraformaldehyde and 24.6 g of trimethylchlorosilane were added into the PSF solution; afterwards, 1.178 g stannic chloride was added dropwise, the resulting solution was heated at 50 ° C. for 48 h. The final PS—Cl was obtained by pouring the solution into ethanol bath, followed by drying at 60 ° C. in an oven for 12 h.

### Example 5

### Preparation of PS—Cl Ultrafiltration Membrane

PS—Cl ultrafiltration membrane was prepared via the non-solvent phase inversion method of Lin et al (X. Lin, K. Wang, Y. Feng, J.Z. Liu, X. Fang, T. Xu, H. Wang, “Composite ultrafiltration membranes from polymer and its quaternary phosphonium-functionalized derivative with enhanced water flux”, J. Membr. Sci., 482, 2015, pp 67-75). A 25 wt % PS—Cl/NMP solution was firstly formed by dissolving PS—Cl polymer in NMP. After ultrasonication to remove the bubbles, the PS—Cl NMP solution was cast onto a glass plate using a Gardco® adjustable micrometer film applicator with a stainless-steel blade (Paul N. Gardner Company, Inc. USA), whose gap was set as 250 μm. After immersing the glass plate into a water bath for non-solvent phase inversion, the PS—Cl ultrafiltration membrane was obtained.

### Example 6

### Preparation of Porous N,N,N′,N′-tetramethyl-1,3-propanediamine (TMPDA) Modified Polysulfone (PSF) Anion Exchange Membranes (TPSF AEMs)

As shown in Scheme 2, porous AEMs were prepared using methods similar to those employed for Example 1.

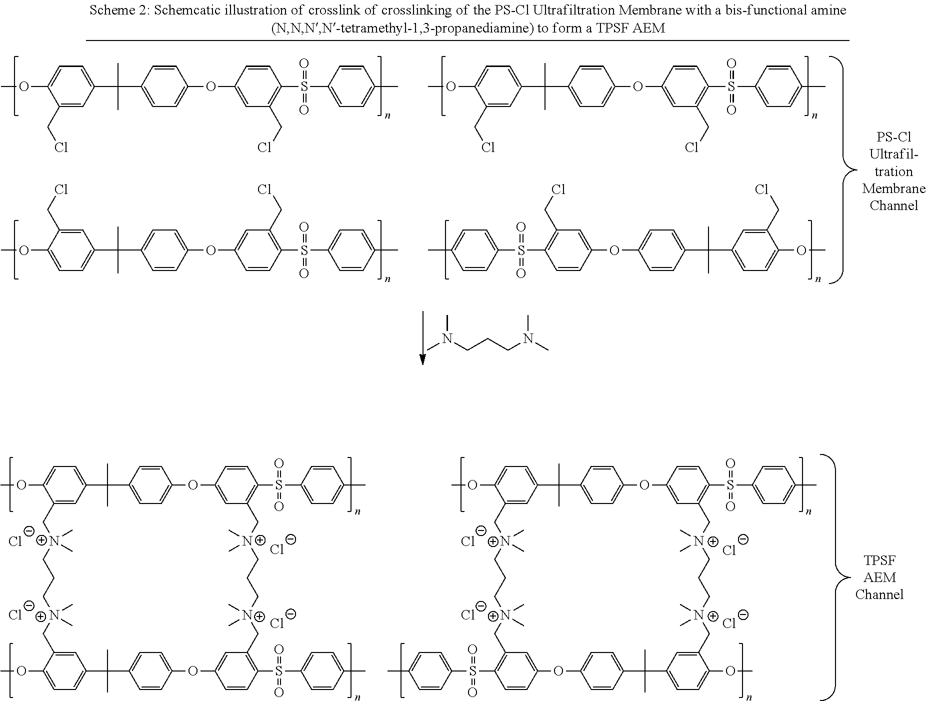

Scheme 2 is merely illustrative and depicts only two of the possible cross linking arrangements, wherein two adjacent chloromethyl groups on one PSF polymer strand form crosslinks with two adjacent chloromethyl groups on another PSF polymer strand within the PS—Cl ultrafiltration membrane channel. The skilled artisan will be aware that numerous other cross linking arrangements are possible, including arrangements wherein two adjacent chloromethyl groups on one PSF polymer strand form crosslinks with non-adjacent chloromethyl groups on another PSF polymer strand within the PS—Cl ultrafiltration membrane channel, and wherein two adjacent chloromethyl groups on one PSF polymer strand form crosslinks with chloromethyl groups on separate PSF polymer strands within the PS—Cl ultrafiltration membrane channel and/or with chloromethyl groups on the same polymer strand that the two adjacent chloromethyl groups are attached to within the PS—Cl ultrafiltration membrane channel.

To prepare the TPSF AEM, pre-formed PS—Cl ultrafiltration membrane was simply immersed in 1 mol L⁻¹N,N,N′,N′-tetramethyl-1,3-propanediamine (TMPDA) solution at 60° C. for different times to tailor the membrane microstructure and diffusion dialysis related performance. The final AEMs prepared from PS—Cl ultrafiltration membrane treated by TMPDA were prepared under immersison treatment times of 1, 2, 3, 4 and 5 hours.

To measure the Ion Exchange Capacity (IEC) of the prepared TPSF AEMs, the membrane sample was firstly immersed in 0.2 mol L⁻¹ NaOH aqueous solution at 25 ° C. for 12 h to ensure that all Cl⁻ ions within the membrane were ion-exchanged with OH⁻. After thoroughly washing with water, the sample was ion-exchanged again by immersing in 1 mol L⁻¹ NaCl aqueous solution at 25 ° C. for 12 h. The amount of the released OH⁻ was measured by titration using a freshly prepared HCl solution as titrant and methyl orange as indicator. The IEC with units of mmol of OH⁻ per gram of dry membrane can be calculated via the equation IEC=(C×V)/W, where C and V are the concentration and the consumed volume of HCl solution, respectively, and W is the dry weight of the membrane.

The ion exchange capacity (IEC) of non-cross linked PC-Cl membranes was tested as a control experiment and a zero IEC was confirmed. The IEC values of the TPSF AEMs depend on the immersion time, with longer immersion times resulting in higher IEC. Increasing the immersion time from 1 hour to 4 hours produced a steady, approximately linear increase in IEC from 0.72 to 1.18 mmol g⁻¹, consistent with the expectation that increasing immersion time allows the extent of reaction between —CH₂Cl and TMPDA to progress. Upon increasing the immersion time from 4 hours to 5 hours, no significant further increase in IEC was observed, consistent with the full conversion of —CH₂Cl groups to quaternary ammonium groups.

While this disclosure has been described in connection with specific embodiments thereof, it will be understood that it is capable of further modification(s). This application is intended to cover any variations uses or adaptations of the disclosure following in general, the principles of the disclosure and including such departures from the present disclosure as come within known or customary practice within the art to which the disclosure pertains and as may be applied to the essential features hereinbefore set forth.

As the present disclosure may be embodied in several forms without departing from the spirit of the essential characteristics of the disclosure, it should be understood that the above described embodiments are not to limit the present disclosure unless otherwise specified, but rather should be construed broadly within the spirit and scope of the disclosure. The described embodiments are to be considered in all respects as illustrative only and not restrictive.

Various modifications and equivalent arrangements are intended to be included within the spirit and scope of the disclosure. Therefore, the specific embodiments are to be understood to be illustrative of the many ways in which the principles of the present disclosure may be practiced. In the following, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A method for manufacture of an asymmetrically porous ion exchange membrane comprising the steps of;
(1) provision of an ultrafiltration membrane, comprising the steps of:
(i) forming a solution comprising 10-40 wt % of one or more halogen methylated polysulfones;
(ii) casting the solution to a thickness of 10-500 micron, and subjecting the cast solution to a coagulation bath to form the ultrafiltration membrane via phase inversion; and
(2) modification of the resultant ultrafiltration membrane to provide a cross-linked asymmetrically porous ion exchange membrane, wherein the modification comprises the sub-step of exposing the ultrafiltration membrane of step (1) to a bis-functional reagent including an imidazole or an amine containing at least two amine groups, selected from the group consisting of N,N,N′,N′--tetramethylethylenediamine, N,N,N′,N′--tetramethyl-1,3 -propanediamine, N,N,N′,N′--tetramethyl-1,4-butanediamine, N,N,N′,N′--tetramethyl-1,6-hexanediamine, N,N-dimethylethylenediamine, 3-(dimethylamino)-1-propylamine, 3,3′-iminobis(N,N-dimethylpropylamine), and 1,4-diazabicyclo [2.2.2] octane; including mixtures of two or more of any of the aforementioned bis-functional reagents.

2. The method according to claim 1 wherein the one or more halogen methylated polysulphones are selected from the group consisting of chloromethylated polysulfone (PS—Cl) and chloromethylated polyethersulfone (PES—Cl).

3. A diffusion dialysis membrane manufactured according to the method of claim 1.

4. A method for manufacture of an anion exchange membrane comprising the steps of:
(1) provision of an ultrafiltration membrane, comprising the steps of:
(i) forming a solution comprising 10-40 wt % of one or more halogen methylated polymers,
(ii) casting the solution to a thickness of 10-500 micron, and
(iii) subjecting the cast solution to a coagulation bath to form the ultrafiltration membrane; and
(2) modification of the resultant ultrafiltration membrane to provide an asymmetric porous anion exchange membrane comprising the sub-step of exposing the ultrafiltration membrane of step (1) to a single bis-functional reagent including an imidazole or an amine containing at least two tertiary amine groups.
